(19) United States
(12) Patent Application Publication
(10) Pub. No.: US 2018/0191169 A1
(43) Pub. Date: Jul. 5, 2018

(54) CHARGING BEACON AND SYSTEM

(71) Applicant: Griffin Technology, LLC, Irvine, CA (US)

(72) Inventors: Andrew Biddle, Nashville, TN (US); Aaron Wierenga, Nashville, TN (US)

(21) Appl. No.: 15/727,546

(22) Filed: Oct. 6, 2017

Related U.S. Application Data
(60) Provisional application No. 62/442,418, filed on Jan. 4, 2017.

(51) Int. Cl. H02J 7/00; H01M 10/48; H01M 10/42

(52) U.S. Cl. CPC H02J 7/0004; H01M 10/4257; H01M 10/48

(57) ABSTRACT

A charging beacon and system is disclosed. The system comprises one or more charging beacons comprised of one or more interactive charging devices that wirelessly broadcast signals, repeatedly at regular time intervals. Upon receipt of the signal, a user's electronic device process the signal via an application residing on the device and provides various information including notice of the battery charge condition in the electronic device and the proximity of the charging device. The broadcast signal may include a unique identifier that allows the electronic device to process the signal and determine the identity of the charging device emitting the broadcast signal. A plurality of charging devices may be positioned in various locations in the home, at work, in the car, and/or in public places to create a mesh network of charging beacons. The wireless broadcast cast signal may be emitted via a Bluetooth Low Energy (BLE) radio and received by a BLE module in the electronic device.

### INCORPORATION BY REFERENCE TO RELATED APPLICATIONS

This application claims benefit under 35 U.S.C. § 119(e) from U.S. Provisional Application No. 62/442,418, filed on Jan. 4, 2017, which is hereby incorporated herein by reference in its entirety.

### BACKGROUND OF THE INVENTION

### Field of the Invention

This patent document relates to charging beacons and systems and more particularly to interactive charging devices and systems capable of providing wireless notification to the user of the presence and proximity of the charging device.

### Description of the Related Art

Portable electronic devices or mobile devices such as smart and cellular phones, computing tablets, MP³/audio/video players, gaming devices and laptops are continuously and rapidly evolving to meet expanding consumer demands. With each new feature (e.g., camera, text, cellular, social media, wireless payment), reliance on such devices increases. Unfortunately, battery power can be insufficient and often times does not keep up with the demands of the device frequently leaving a user with limited or no warning of a depleted battery condition or a means for finding a suitable power source to recharge the device.

The inventors here have recognized that there is a need, therefore, for an interactive charging device and system capable of notifying or prompting users of the level of the battery charge on their devices and the presence and proximity of nearby suitable charging device.

### SUMMARY OF THE INVENTION

Various aspects of the disclosed system are disclosed herein, including in the drawings. Such aspects may be combined to form claims for a device, apparatus, system, method of manufacture, and/or use without limitation.

### BRIEF DESCRIPTION OF THE DRAWINGS

Features, aspects and advantages are described below with reference to the drawings, which are intended to illustrate but not to limit the invention. In the drawings, like reference characters denote corresponding features consistently throughout similar embodiments.

FIG. 1 illustrates a charging beacon system diagram that includes a plurality of charging beacons positioned throughout a location and an automobile. Each charging beacon is comprised of a BLE enabled power charger device having a power input connection and a power output port and being configured to broadcast a digital electronic signal when the power input is connected to a power source. A BLE enabled portable or mobile electronic device installed with an interactive application receives the broadcast signal and determines from the signal the identification of the charging device and its relative proximity thereto. Receipt of the signal also prompts the portable or mobile electronic device to check the battery charge level and, subject to satisfying pre-set criteria, provides notification to the user of the of the charge level of the battery.

FIGS. 2A-2B are perspective views of a charging beacon devices configured as a BLE enabled wall charging adapter. FIG. 2C is a top view of the charging beacon depicted in FIGS. 2A-2B further illustrating i the broadcast digital electronic signals emanating from the charging device.

FIG. 3A is perspective view of another embodiment of a charging beacon device configured as a BLE enabled car charging adapter. FIG. 3B is a top view of the charging beacon depicted in FIG. 3A further illustrating the broadcast digital electronic signals emanating from the charging device.

FIG. 4 is yet another embodiment of a charging beacon in the form of a BLE enabled USB adapter.

FIG. 5 is a block diagram showing main components of a charging beacon device and it's interaction with a mobile device.

FIG. 6 is a flow diagram showing the decision logic for processing an incoming broadcast signal from a charging beacon, such as the those illustrated in FIGS. 2-5.

FIG. 7A illustrates a representative user interface screen of a mobile electronic device depicting notification message to the user of the battery level and that a charging beacon is close by. The user interface screen is generated in response to the mobile electronic device receiving signal broadcasted from the charging beacon and processing the signal. An application is resident on the mobile device. Upon receipt of the signal, the application queries for information regarding the battery state of the mobile device and determines whether the battery level satisfies a notification threshold based a preset of user preference criteria. If the criteria are met than the notification is generated on the display screen of the mobile electronic device as depicted.

FIG. 7B illustrates a representative user interface screen generated by the charging beacon application resident on the mobile electronic device that allows the user to assign one or more charging beacons to multiple locations and adjust the percentage at which the user is notified per location.

Each drawing is generally to scale and hence relative dimensions of the various layers can be determined from the drawings. Common or corresponding elements in each drawing are referred to using the same reference numerals.

### DETAILED DESCRIPTION OF THE PREFERRED EMBODIMENT

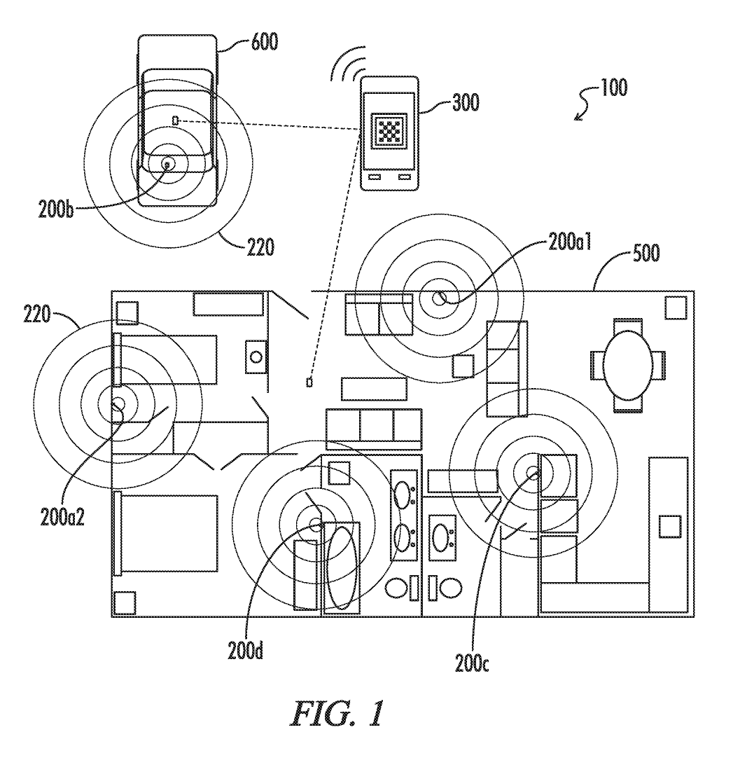

As described herein and illustrated in the drawings, disclosed herein are various aspects of a charging beacon and system 100 that as illustrated in FIG. 1 includes a plurality of Bluetooth Smart Technology (Bluetooth Low Energy or BLE) enabled power chargers or charging adapters 200 (which can be in different variations such a wall adapter 200a1 or 200a2 for plugging into an AC wall socket in a house 500 or other constructions, a car adapter 200b for plugging into a DC socket of a car 600 or other DC source, a USB adapter 200c, a battery pack 200d, etc.) and an interactive application 400. The application is stored in non-transient memory on the user's BLE enabled portable electronic device 300 and is capable of generating graphical user interfaces on an interactive touchscreen display 301. BLE is a wireless personal area network technology designed and marketed by the Bluetooth Special Interest Group, the specifications of which can be found at https:///www.bluetooth.com/specifications/adopted-specifications.

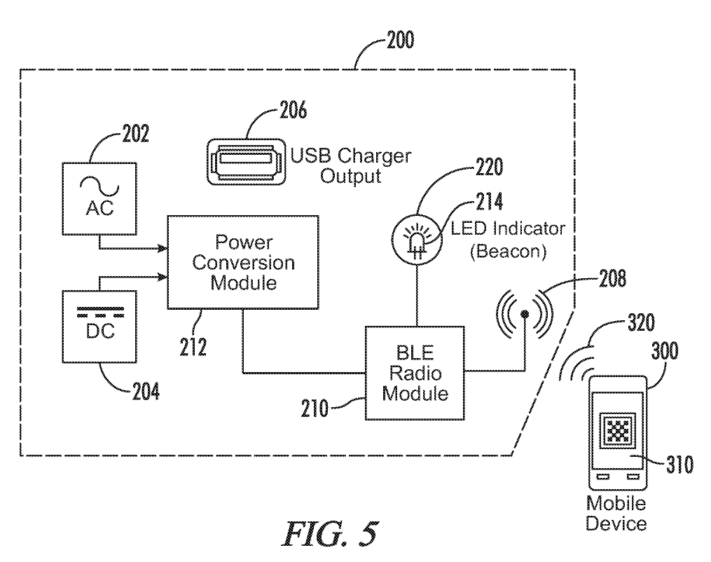

As best depicted in the block diagram of FIG. 5, each charging beacon 200 has a power conversion module 212 that can receive electrical current from the AC power input 202 or the DC power input 204, or both, and convert the received electrical current to a USB compatible power source and deliver it through one or more USB charger output 206.

The power conversion module 212 can include an AC/DC converter (not shown) to convert the electrical current received from the AC power input 202 to a DC current. The AC/DC converter can be selected from any commercial AC/DC converters or specific designed AC/DC converters. The power conversion module 212 can include a DC/DC converter (not shown) to convert the electrical current received from the DC power inputs 204 to a DC current. One example of the DC/DC converters is the MP2496M frequency selectable step-down converter manufactured by Monolithic Power Systems (MPS). It is understood that other DC/DC converters can also be used. In the present embodiment, the one or more USB charger output 206 can supply a 5V/3A electrical power.

The charging becon 200 is also configured to include a BLE radio module 210 to broadcast digital electronic signals 208, which contains a 128 bit universally unique identifier (UUID) at a frequency of 2.4 Ghz to indicate the product type and available charging rates. One example of the BLE radio modules 210 is the SESUB-PAN-D14580 Bluetooth Module manufactured by TDK.

The UUID can be specific to one of the BLE enabled power chargers or adapters 200 (e.g., wall charging adapter 200a1, 200a2, car charging adapter 200b, USB charging adapter 200c, battery pack 200d, etc.). Table 1 depicts an example of a portion of information the UUID can specify.

TABLE 1

| Power Charger/ | | |
|---|---|---|
| Adapter Number | Type | Available Charge Rate |
| 200a1 | Wall Charging Adapter | 1 A, 2.1 A, 2.4 A |
| 200a2 | Wall Charging Adapter | 1 A, 2.1 A, 2.4 A |
| 200b | Car Charging Adapter | 1 A, 2.1 A, 2.4 A |
| 200c | USB Charging Adapter | 500 mA |
| 200d | Battery Pack | 1 A, 2.1 A, 2.4 A |

The charging beacon 200 is configured to broadcast digital electronic signals 208 periodically, for example, every 100 mini second to 500 mini second. Thus the signal from the charging beacon 200 in one implementation is repeatedly transmitted at regular time intervals. The BLE enabled mobile device 300 is installed with the interactive software application (app) 400. Incoming radio signals 208 from the BLE radio module 210 are received by the mobile device 300. The mobile device can be a tablet computer, laptop, or smart phone or other electronic device enabled to receive Bluetooth radio signals.

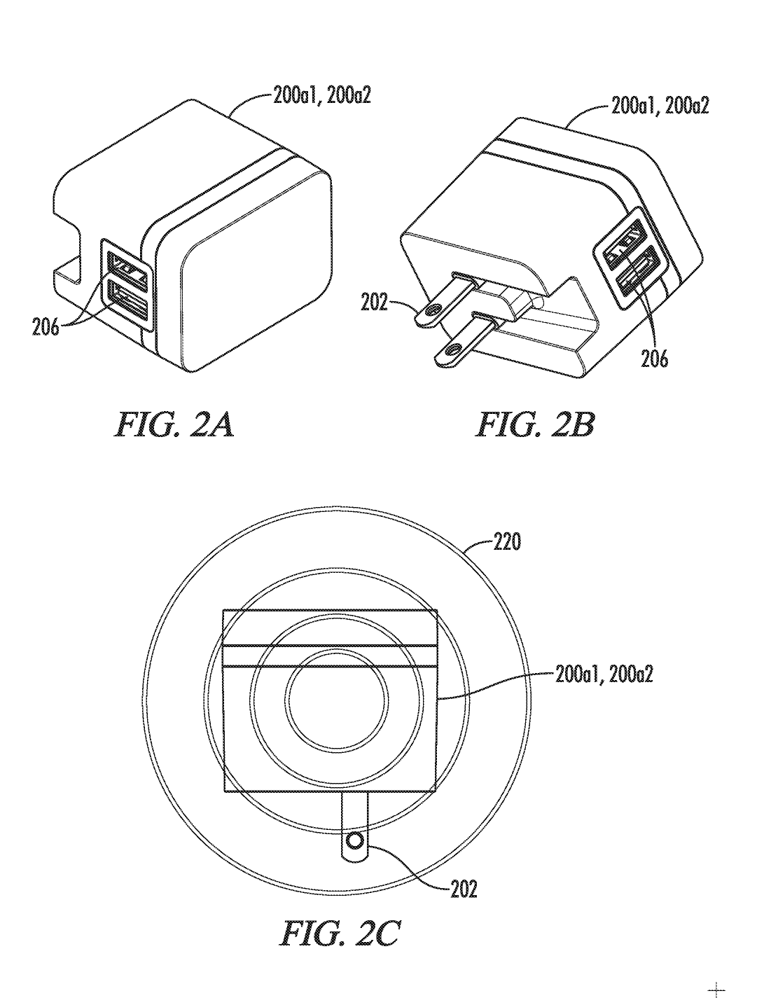

As best shown in FIGS. 2A-2C, the wall adapter 200a1 charging beacon 200 has an AC input 202 and at least one USB output 206. The wall adapter 200a1 is configured to include a BLE Radio module 210 as described previously so as to transmit signals to interact with the application software installed in a mobile device.

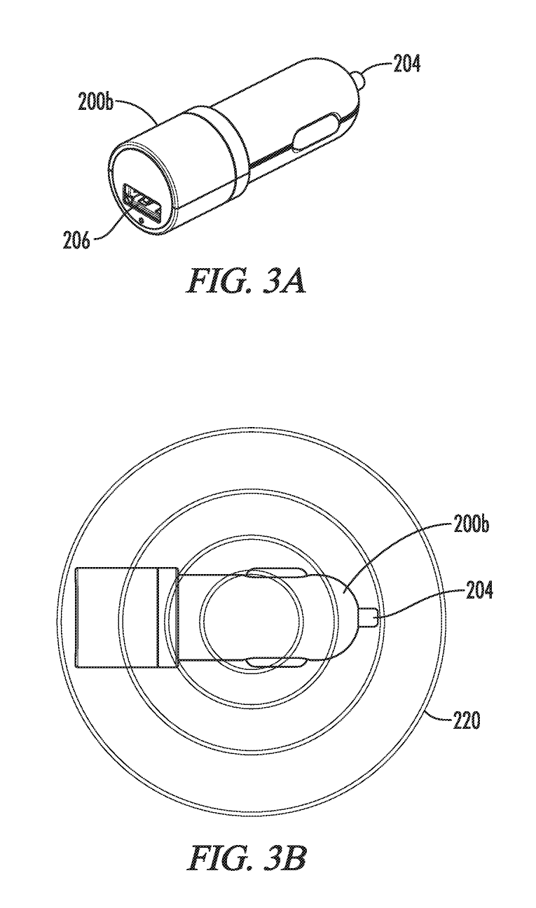

As best depicted in FIGS. 3A-3B, the car adapter 200b charging beacon 200 has a DC input 204 and one USB output 206. The car adapter 200b is configured to include a BLE Radio module 210 as described previously so as to transmit signals to interact with the application software installed in a mobile device.

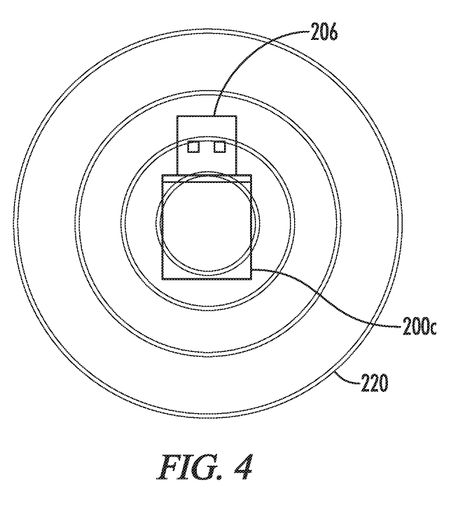

As best depicted in FIG. 4, the USB adapter 200c charging beacon 200 has a USB input (not shown) and one USB output 206. The USB adapter 200c is configured to include a BLE Radio module 210 as described previously so as to transmit signals to interact with the application software installed in a mobile device.

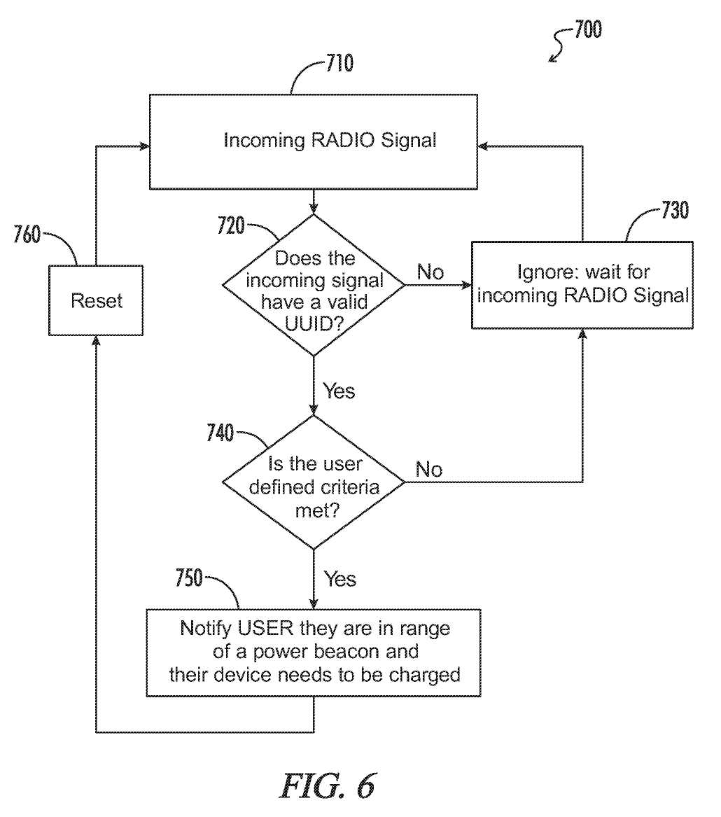

As depicted in FIG. 6, at step 710, the interactive software application 400 installed in the mobile device 300 continuously monitors the 2.4 Ghz frequency band for any incoming radio signals, if the function is turned on.

At step 720, if the incoming radio signals contain a UUID that matches the profile of a previously established table (for example, Table 1), the application 400 will interpret the other information sent with the UUID as an indication of the type of charger/adapter and the charging rate associated with the charger/adapter. The approximate distance between the mobile device 300 and the BLE enabled power charger/adapter 200 can also be determined, for example, by checking the received signal strength indicator (RSSI).

However, if the incoming radio signals do not contain a valid UUID, the system will go to step 730 and then return to step 710 to start all over again.

If the incoming radio signals contain a valid UUID, at step 740, the application 400 will then check if any user defined criteria and/or the mobile device's battery charge level are met.

If the answer is no, the system will go to step 730 and then return to step 710 to start all over again.

If user defined criteria and/or the mobile device's battery charge level are met at step 740, the system will go to step 750 and the mobile device 300 will be instructed by the application to generate a notification (pop-up) to the user indicating that the user is in range of a BLE enabled power charger/adapter and the mobile device 300 needs to be charged.

The LED 214 of a charging beacon can be further provides a light indicator to signify the presence of a charging beacon 200.

The user defined criteria can be configured in several ways. Some examples are shown in Table 2 below:

TABLE 2
User Defined Criteria

To look for any charging beacon
To look for a specific charging beacon
To look for a charging beacon that meets the mobile device's battery
charging requirements
To look for specific charging beacon only when the mobile device's
battery charge drops below a predefined threshold
Proximity to a charging beacon before notification is provided
The battery level threshold of the mobile device that triggers notification

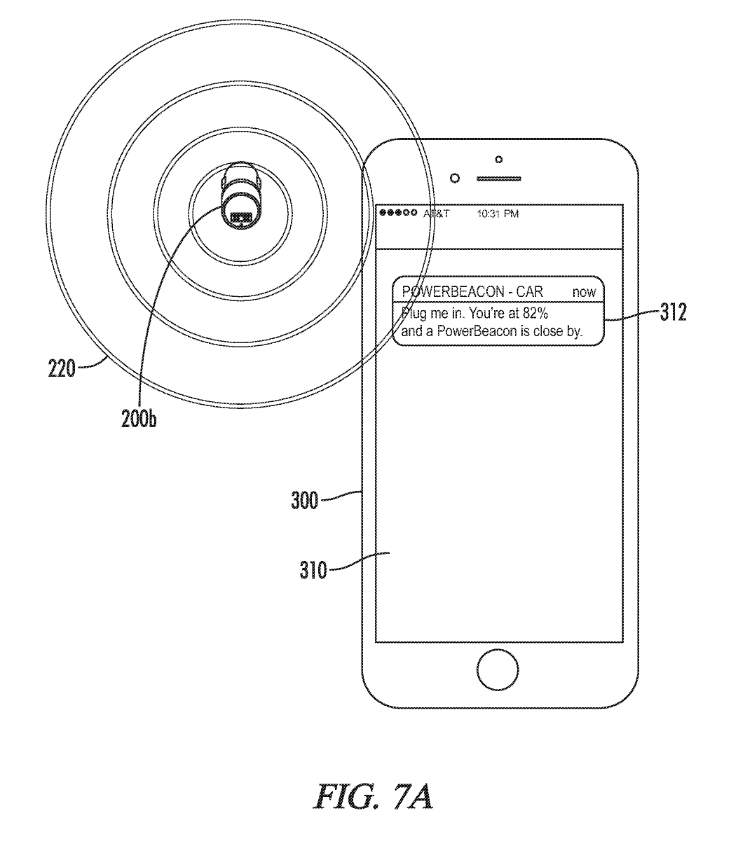

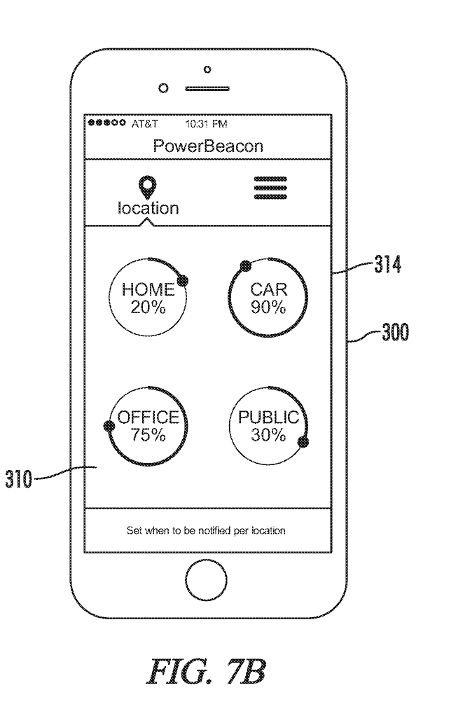

When the application on the mobile device detects the presence of a charging beacon that is capable of charging the mobile device, the application will query the battery state of the mobile device. If the user's criteria is met, for example, the state of the mobile device's battery charge is below a notification threshold and an acceptable charging beacon is nearby proximity, and/or the other criteria are met based on the user's preferences listed above, a notification can be displayed on the mobile device, as shown in FIG. 7A.

The application allows the user to assign one or more charging beacons to multiple locations. The user may also adjust the percentage at which the user is notified, per location, as shown in FIG. 7B.

The interactive application 400 may, for example, be operable on mobile operating systems including, iOS, Android, Windows, Blackberry and others that natively support BLE so as to be capable of communicating with the BLE enabled charging beacons 200. FIG. 1, and the other drawings herein, illustrates the application 400 on an iPhone 6 smart phone that operates on Apple iOS. The audio application 400 utilizes BLE to send commands and receive communications from the BLE enabled charging beacons 200.

Each of the foregoing and various aspects, together with those set forth in the claims and described in connection with the embodiments of the protective cases summarized above or otherwise disclosed herein including the drawings may be combined as claim limitations for a device, apparatus, system, method of manufacture, and/or use.

Although the various inventive aspects are herein disclosed in the context of certain preferred embodiments, implementations, and examples, it should be understood by those skilled in the art that the present invention extends beyond the specifically disclosed embodiments to other alternative embodiments and/or uses of the invention and obvious modifications and equivalents thereof. Thus for example, while a BLE wireless communication protocol and hardware is described it should be understood that other wireless communication protocols may be employed. In addition, while a number of variations of the various aspects have been shown and described in detail, other modifications, which are within their scope will be readily apparent to those of skill in the art based upon this disclosure. It should be also understood that the scope this disclosure includes the various combinations or sub-combinations of the specific features and aspects of the embodiments disclosed herein, such that the various features, modes of implementation, and aspects of the disclosed subject matter may be combined with or substituted for one another. Thus, it is intended that the scope of the present invention herein disclosed should not be limited by the particular disclosed embodiments or implementations described above.

What is claimed is:

1. A charging beacon system comprising:
a plurality of BLE enabled power charger devices, each having a power input connection and a power output port and being configured to broadcast a digital electronic signal when the power input is connected to a power source;
a battery powered BLE enabled mobile electronic device configured to receive the broadcasted digital electronic signal; and
a software application installed on the mobile electronic device, wherein the software application is configured to process said digital electronic signal prompt notification of the power level in the battery and determine the identity of the device broadcasting the signal and its proximity relative to the electronic device.

2. The charging beacon system of claim 1, wherein the digital electronic system is broadcast repeatedly at regular time intervals.

3. The charging beacon system of claim 1, wherein the determination of the proximity is based on the received signal strength of the digital electronic signal.

4. The charging beacon system of claim 1, wherein the determination of the identity of the device broadcasting the signal is derived at least in part from a unique identifier data transmitted in the broadcasted signal.
